(19) United States
(12) Patent Application Publication
(10) Pub. No.: US 2004/0148520 A1
(43) Pub. Date: Jul. 29, 2004

(54) Mitigating denial of service attacks

(76) Inventors: Rajesh Talpade, Madison, NJ (US); Sunil Madhani, Morristown, NJ (US); Petros Mouchtaris, Berkely Heights, NJ (US); Larry Wong, Parsippany, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 10/353,527

(22) Filed: Jan. 29, 2003

(51) Int. Cl. G06F 11/30

(52) U.S. Cl. 713/201

(57) ABSTRACT

Service attacks, such as denial of service and distributed denial of service attacks, of a customer network are detected and subsequently mitigated by the Internet Service Provider (ISP) that services the customer network. A sensor examines the traffic entering the customer network for attack traffic. When an attack is detected, the sensor notifies an analysis engine within the ISP network to mitigate the attack. The analysis engine configures a filter router to advertise new routing information to the border and edge routers of the ISP network. The new routing information instructs the border and edge routers to reroute attack traffic and non-attack traffic destined for the customer network to the filter router. At the filter router, the attack traffic and non-attack traffic are automatically filtered to remove the attack traffic. The non-attack traffic is passed back onto the ISP network for routing towards the customer network.

### BACKGROUND OF OUR INVENTION

1. Field of the Invention

Our invention relates generally to mitigating service attacks, such as denial of service attacks and distributed denial of service attacks (collectively referred to as DDoS attacks), on a communications network. More particularly, our invention relates to detecting DDoS attacks directed at edge/customer networks and to mitigating such attacks by redirecting the DDoS and non-DDoS traffic within a service providers network and then selectively removing the DDoS traffic before it reaches the edge/customer networks.

2. Description of the Background

Denial of service (DoS) and distributed denial of service (DDoS) attacks are a continuing and growing concern on the Internet. In a DoS attack, a computer floods a target system with large amounts of bogus network traffic. DDoS attacks are similar to DoS attacks but occur on a larger scale. Here, a hacker uses a client computer to infiltrate multiple agent computers, which are typically geographically distributed across the Internet. Once accessing an agent, the hacker installs a software module that is controlled by the client computer and is later used by the client computer in conjunction with the other agents to flood a target network and/or server(s) with bogus network traffic. As compared to DoS attacks, DDoS attacks are more disruptive because of the heavier traffic volume they generate and because of the numerous traffic sources, making it more difficult to stop the attack.

In general, DoS and DDoS attacks are intended to consume bandwidth in the target network and to overtax target servers thereby preventing legitimate traffic/users from accessing the target network and servers. These attacks are a serious problem today because they are relatively easy to create using attack tools, such as TFN2K and Stacheldraht, which are readily available off the Internet. Overall, DoS and DDoS attacks can shutdown a network and therefore a business for hours and possibly days.

Prior systems have been developed to detect and mitigate DoS and DDoS attacks (hereinafter, DDoS will be used to refer to both DoS and DDoS attacks). These systems reside entirely within an entity's network and both detect and mitigate the attacks at this point. Specifically, FIG. 1 shows an exemplary network comprising the Internet 102, an ISP (Internet service provider) network 104, an edge/customer network 106 being served by the ISP network 104, and a plurality of peer autonomous systems 108, 110, and 112. The Internet 102, ISP network 104, and peer autonomous systems 108, 110, and 112 are interconnected by border routers 114, 116, 118, 120, 122, 124, 126, and 128, while the ISP network 104 and customer network 106 are interconnected by edge router 130, access router 132, and access link 134. A DDoS attack against a target network, such as customer network 106 and servers within this network, can originate from a plurality of agents located in Internet 102 and peer autonomous systems 108, 110, and 112. Prior DDoS detection and mitigation systems comprise dedicated hardware that resides within the customer network 106. These systems mitigate DDoS attacks by monitoring Internet traffic entering the network. They analyze this traffic to determine if there is a deviation from an expected traffic profile or to determine if the traffic has a signature unique to a certain kind of attack (i.e., the packets generated by each type of DDoS attack have a unique pattern, depending on the type of attack, which pattern is referred to as signature). When these systems detect traffic that goes against the expected profile or matches a known signature, they configure a set of filters and act like a firewall, preventing the malicious traffic from further entering the network 106.

While these systems are able to detect and mitigate attacks, they have several disadvantages. First, each customer network 106 being serviced by an ISP is required to purchase dedicated hardware to detect and mitigate attacks. While dedicated hardware may be an option for large customers, it is not a viable solution for smaller customers, such as SOHO (small office/home office) customers, which cannot afford these systems. As a result, these smaller customers turn to the ISP to mitigate DDoS attacks. However, mitigation is often difficult for ISPs because malicious clients/agents often use IP (Internet protocol) source address spoofing to hide their identity. Because of the IP spoofing, the ISPs cannot easily determine the ingress points of the malicious traffic into their networks without first accessing in-service routers, and as a result, the ISPs cannot easily set-up appropriate filters to remove the malicious traffic. A second disadvantage of these prior systems is that it is difficult to mitigate DDoS attacks at the target. Specifically, as indicated above, once a DDoS attack is detected, filtering of the traffic is done at the customer network 106. As such, the ISP network 104 continues to aggregate and direct both the malicious and valid network traffic at the customer network 106 through the edge router 130, access router 132, and access link 134, which access link may have relatively small bandwidth, e.g., a few 100 kbps, such as a T-1, digital subscriber line, or ISDN (integrated services digital network). Hence, while these prior systems remove the bottleneck from within the customer network 106, they allow the DDoS attack to continue consuming the limited resources that are used to access the customer network (including the edge router, access link, and access router) and thereby allow the DDoS attack to continue creating a bottleneck for valid network traffic. As a result, valid network traffic intended for the customer network 106 must still compete with the malicious traffic. Hence, these current systems do not completely mitigate the problem.

### SUMMARY OF OUR INVENTION

Accordingly, it is desirable to have methods and apparatus that overcome the disadvantages of prior systems and detect and mitigate service attacks, including DDoS attacks, against customer networks. Specifically, in accordance with our invention, a sensor is associated with each customer network of the ISP network. The sensor is a module that comprises a plurality of sensor filters that have access to the network traffic entering the customer network and are directed at detecting DDoS attacks. The sensor module executes on a host platform installed in the customer network or in the ISP network. This host platform is either dedicated to detecting DDoS traffic or is an existing platform already installed in the customer or ISP network and is responsible for other functions. When the sensor detects an attack, it notifies an analysis engine located in the ISP network in order to mitigate the attack.

Upon receiving an attack notification and based on the customer network being attacked, the analysis engine configures one or more filter routers, which are also located in the ISP network. Specifically, each filter router maintains an IP-in-IP tunnel with all or a subset of the border and edge routers that comprise the ISP network and further maintains through these IP-in-IP tunnels an external border gateway protocol (eBGP) session with each of its connected border and edge routers. The analysis engine configures the filter router(s) to advertise new routing information to the border and edge routers using the eBGP session. The new routing information instructs the border and edge routers to reroute all DDoS and non-DDoS traffic directed at the customer network under attack to the filter router using the IP-in-IP tunnels.

At the ingress ports of the IP-in-IP tunnels, at the filter router, are a set of pre-provisioned traffic filters. The redirected DDoS and non-DDoS traffic from the border and edge routers is automatically passed through these filters, removing the DDoS traffic. The non-DDoS traffic is forwarded back onto the ISP network and routed towards the customer network.

As a result of our inventive detection and mitigation system, the DDoS traffic is removed by high-end systems while still resident within the ISP network and is never aggregated and directed towards the customer network, allowing the non-DDoS traffic to move towards the customer network largely unaffected by the DDoS attack. In addition, as the ISP network grows, our inventive system easily scales by adding additional filter routers and border/edge routers. Furthermore, because IP-in-IP tunnels are used to redirect the DDoS and non-DDoS traffic from the border and edge routers to the filter router, the routers comprising the core of the ISP network do not need to be reconfigured when mitigating the attack. As a result, our inventive system does not affect traffic directed at customer networks that are not the subject of the attack. Finally, our inventive system does not require dedicated/special hardware be installed in each customer network.

### BRIEF DESCRIPTION OF THE DRAWINGS

FIG. 1 depicts a prior art illustrative network to which our inventive DDoS detection and mitigation system is applicable, the network comprising an ISP network, a customer network serviced by the ISP network, and a plurality of peer autonomous systems to the ISP network.

FIG. 2 depicts an illustrative embodiment of our inventive DDoS detection and mitigation system applied to the network depicted in FIG. 1, our inventive system comprising a sensor for detecting DDoS attacks directed at the customer network and further comprising an analysis engine, filter router, border/edge routers, and IP-in-IP tunnels in the ISP network for mitigating detected attacks.

FIGS. 3A-3C depict an illustrative example of the operation of our invention DDoS detection and mitigation system as depicted in FIG. 2, FIG. 3A showing a customer network receiving DDoS and non-DDoS traffic, FIG. 3B showing the sensor that is associated with the customer network notifying the analysis engine of the attack and further showing the analysis engine configuring the filter router to advertise to the border and edge routers through the IP-in-IP tunnels new routing information regarding traffic destined for the customer network, and FIG. 3C showing the DDoS and non-DDoS traffic being redirected by the border and edge routers through the IP-in-IP tunnels to the filter router and the filter router removing the DDoS traffic and passing the non-DDoS traffic back onto the ISP network for routing to the customer network.

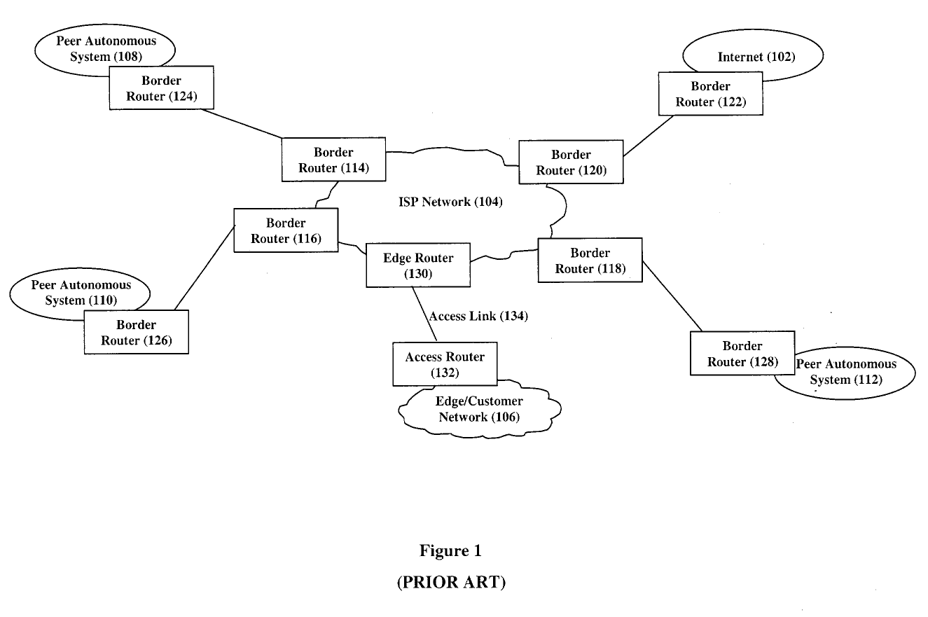

### DETAILED DESCRIPTION OF OUR INVENTION

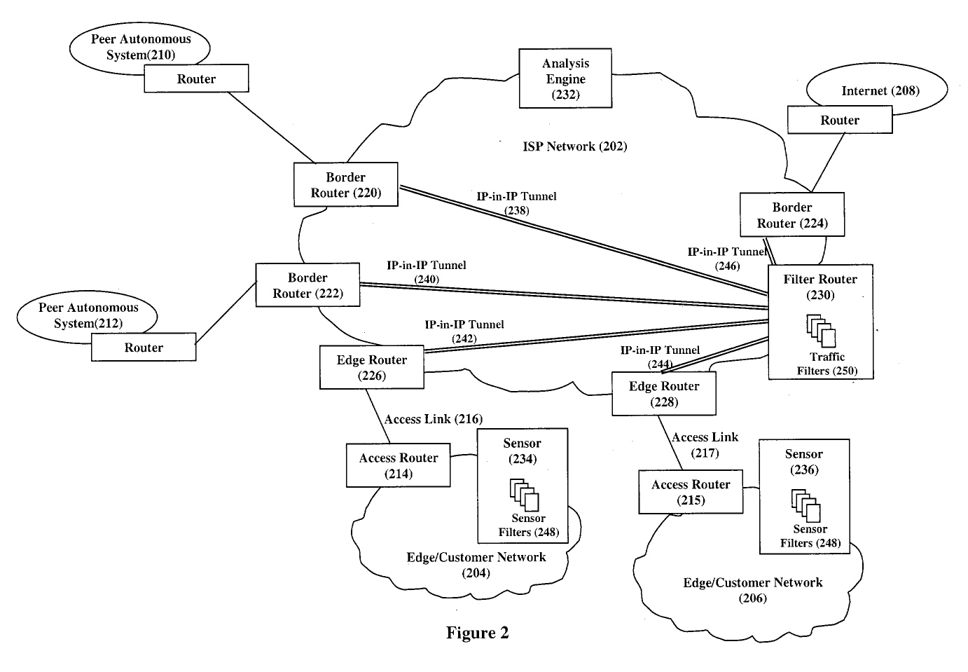

FIG. 2 is a diagram of an illustrative embodiment of our inventive DDoS detection and mitigation system for dynamically detecting DDoS attacks in edge/customer networks 204/206 and for mitigating these attacks. Uniquely, our inventive system detects DDoS attacks directed at the customer networks 204/206 and mitigates these attacks in the ISP network 202. Importantly, our inventive system does not require the installation of special dedicated hardware in each customer network. As important, because our inventive system mitigates the DDoS attacks within the ISP network, malicious traffic is not directed through the edge routers 226/228, access routers 214/215, and access links 216/217 towards the customer networks 204/206 and thereby effectively removes the affects of the DDoS traffic on the non-DDoS traffic.

Specifically, our inventive DDoS detection and mitigation system comprises existing infrastructure within the ISP network 202, including the border routers 220, 222, and 224 and edge routers 226 and 228, and further comprises one or more filter routers 230 (only one filter router is shown in FIG. 2) situated within the ISP network, a plurality of traffic filters 250 located within the filter router 230, pre-provisioned IP-in-IP tunnels 238, 240, 242, 244, and 246 from each border and edge router to each filter router, an analysis engine 232 located within the ISP network, sensors 234/236 associated with each customer network 204/206, and a plurality of sensor filters 248 located in each sensor 234/236. The ISP network 202 may further comprise a plurality of core network routers and connections, which routers and connections interconnect the analysis engine 232, the filter router 230, and the border and edge routers 220, 222, 224, 226, and 228. These core routers and connections are note shown in FIG. 2 for ease of description.

In accordance with our invention, the sensors 234/236 monitor all traffic entering the customer networks 204/206 from the ISP network 202 through edge routers 226/228, access links 216/217, and access routers 214/215, and analyze this traffic through the sensor filters 248 for possible DDoS attacks. A DDoS attack against a customer network, such as network 204, may originate from the Internet 208, peer autonomous systems 210 and 212, and/or from other customer networks 206 being serviced by ISP network 202. When a sensor, such as sensor 204, detects an attack, it communicates the attack to the analysis engine 232. Upon receiving an indication of such an attack, the analysis engine 232 configures one or more filter routers 230 to advertise new routing information to each border router 220, 222, and 224 and each edge router 228 (or a subset of the border routers and edge routers if more than one filter router is being used). The filter router 230 advertises this new routing information to the border and edge routers through the IP-in-IP tunnels 238, 240, 244, and 246. The new routing information instructs the border and edge routers to reroute all DDoS and non-DDoS traffic destined for customer network 204 to the filter router 230 using the IP-in-IP tunnels 238, 240, 244, and 246. The traffic filters 250 are pre-provisioned at the ingress ports of the IP-in-IP tunnels 238, 240, 244, and 246 and automatically filter the traffic redirected from the border and edge routers, removing the DDoS traffic and forwarding all non-DDoS traffic back onto the ISP network 202 towards the customer network 204. As a result of our inventive detection and mitigation system, the DDoS traffic is removed by high-end systems while still resident within the ISP network 202 and is never aggregated and directed towards the customer network 204 through the edge router 226, access link 216, and access router 214 thereby avoiding a bottleneck within these resources. Hence, non-DDoS traffic can continue to move towards the customer network 204 largely unaffected by the DDoS attack.

Importantly, as is further described below, the sensors 234/236 and sensor filters 248 preferably reside on existing hardware modules within the customer and/or ISP networks, thereby avoiding the need to install dedicated special hardware in the customer networks. Additionally, because IP-in-IP tunnels 238, 240, 242, 244, and 246 are used to redirect traffic from the border and edge routers 220, 222, 224, 226, and 228 to the filter router 230, no reconfiguration of the ISP network 202 is needed to mitigate DDoS attacks, thereby avoiding possible effects on other traffic and other customer networks serviced by the ISP network 202 that are not a target of the attack. Similarly, our inventive system does not require accessing in-service network routers, including the core network routers and the border and edge routers, in order to mitigate the attack.

Reference will now be made in detail to each of the components comprising our inventive DDoS detection and mitigation system. The sensor 234/236 has visibility to all traffic entering customer network 204/206 from the ISP network 202. The sensor executes on a host platform installed in either the customer network (as shown in FIG. 2) or at the customer network access point to the ISP network 202 (i.e., at a location where the sensor has visibility to all traffic entering the customer network). This host platform is either dedicated to detecting DDoS traffic or is an existing platform already installed in the customer and/or ISP network and is responsible for other functions. Note that in addition to using a sensor 234/236, a DDoS detection and mitigation system in accordance with our invention can also be incorporated with third party intrusion detection systems installed in the customer networks. In such a scenario, the third party intrusion detection system detects DDoS attacks and communicates with the analysis engine 232 to mitigate the attacks as described above. Similarly, our inventive system can be manually activated wherein an administrator of the customer network reports a DDoS attack to the ISP, which in turn activates the analysis engine 232.

Sensor 234/236 monitors all traffic entering a customer network and tracks, through the sensor filters 248, packet type information related to current TCP (transmission control protocol), UDP (user datagram protocol), ICMP (Internet control message protocol), and IP packets flowing into the customer network and tracks rate type information related to the bit rate entering the customer network. The sensor filters 248 comprise several types. A first set of sensor filters 248 use packet-based information to perform signature-based detections of DDoS flood traffic corresponding to known DDoS attack tools, such as Stacheldraht and TFN2K. A second set of sensor filters 248 analyzes packet headers for invalid field values. Specifically, based on protocol standards, we have determined the range of valid values for various packet header fields for various protocols. The sensor filters analyze packet headers looking for field values beyond the defined range of valid values and detect an error when an invalid field value is found. A third set of sensor filters use the bit rate information to perform volume-based detection of DDoS flood traffic based on configurable threshold values. While the signature-based detection of DDoS flood traffic is directed at known attack tools and the packet-header detection is based on defined protocol standards, the volume-based detection is able to detect new/unknown types of DDoS attacks.

In addition to detecting DDoS attacks, a fourth set of sensor filters 248 use the gathered packet information to perform signature-based detection of DDoS control traffic. By detecting control traffic, the sensor filters are able to determine whether a host(s) within the corresponding customer network is being accessed and used as a client or agent for the source of a DDoS attack. Note that in accordance with our invention, other types of sensor filters 248 beyond those described above can also be provisioned at the sensors 234/236.

Regardless of whether DDoS control traffic is detected or whether a DDoS attack is detected, the sensor 234/236 sends a notification of the event to the analysis engine 232. Specifically, when the sensor 234/236 detects DDoS control traffic, it sends a DDoS control signature-based notification to the analysis engine. When the sensor detects a DDoS attack, it sends a DDoS attack-based notification to the analysis engine 232.

Notification communications between the sensor 234/236 and the analysis engine 232 can occur over any type of communications channel. However, communications preferably occur between the sensors 234/236 and the analysis engine 232 through IPSec (IP security) tunnels, which can be manually or automatically established. Additionally, it is preferable that the notifications be formatted using the Intrusion Detection Message Exchange Format (IDMEF) so that the analysis engine can be easily integrated with third party intrusion detection systems, as described above. Such a data format can be implemented using the Extensible Markup Language (XML), for example.

The analysis engine 232 resides within the ISP network 202, for example within a network operations center, and serves one or more sensors 234 and 236 associated with each of the customer networks 204 and 206. As indicated and in accordance with our invention, the analysis engine receives an automatic notification from a sensor when the sensor detects DDoS control traffic or a DDoS attack. When receiving a DDoS control-based notification, the analysis engine notifies an ISP policy manager. When the analysis engine receives a DDoS attack-based notification, it automatically mitigates the attack by configuring one or more filter routers 230. Specifically, the analysis engine configures the filter router(s) to advertise new routing information to the border and edge routers 220, 222, 224, 226, and 228. The new routing information from the filter router instructs the border and edge routers to reroute all DDoS and non-DDoS traffic destined for the customer network under attack to the filter router.

In addition to enabling the ISP network 202 to mitigate a detected attack, the analysis engine 232 also maintains our inventive DDoS detection and mitigation system. Specifically, the analysis engine pre-provisions the traffic filters 250 on the filter engine 230 and the sensor filters 248 on the sensors 234/236. In addition, depending on the defensive posture/policy of the ISP network, the analysis engine can automatically modulate the severity of filtering at the filter router 230 and sensors 234/236 by disabling certain traffic filters 250 and sensor filters 248, thereby creating multi-level filtering.

Similarly, the analysis engine 232 also updates the sensor filters 248 and traffic filters 250. The sensor filters 248 that are used to detect DDoS flood traffic and DDoS control traffic are based on signatures of known attack tools. As new attack tools are devised, new sensor filters are needed that correspond to the signatures of these new tools. As such, the analysis engine can periodically update the sensors 234 and 236 by downloading new sensor filters 248 as needed. Similarly, the traffic filters 250 at the filter router 230 are based on signatures of known attack tools and are also based on expected IP packet flows through the border routers, as is further described below. Again, as new attack tools are devised and network configurations are changed that alter IP routing/flows, the analysis engine can periodically update the filter router 230 by downloading new traffic filters 250 as needed.

Finally, the analysis engine 232 also assists in shutting-down DDoS attacks at the edge of the ISP network. Specifically, the analysis engine can periodically poll packet-drop-counters maintained by the filter router 230 at each of the IP-in-IP tunnels 238, 240, 242, 244, and 246 as the traffic filters 250 drop packets. By knowing which filters are dropping packets, the analysis engine can determine which border and/or edge routers 220, 222, 224, 226, and 230, and hence which peer autonomous systems 208, 210, 212, 204, and 206, are being used to produce the DDoS flood. This has the advantage that in-service network routers, such as the border and edge routers, do not need to be accessed when trying to determine and shut-down the source of an attack.

Similarly, the analysis engine 232 can determine when the DDoS attack has completed and can restore the network back to its original state. Specifically, by periodically polling the packet-drop-counters maintained by the filter router 230, the analysis engine 232 can determine when the counters are no longer incrementing. When they stop incrementing, the analysis engine 232 can conclude that the DDoS attack has terminated. As such, the analysis engine 232 can then configure the filter router 240 to send eBGP routing information to the border and edge routers instructing the routers to no longer redirect DDoS and non-DDoS traffic to the filter router 240, thereby restoring the network to its original state.

Turning to the filter router 230, as indicated, it resides within the ISP network 202. Depending on the size of the ISP network and/or the number and size of customer networks 204 and 206 serviced by the ISP network, our system may comprise a plurality of filter routers. The filter router is a commercial off-the-shelf high-end router with packet filtering firewall capabilities, with a plurality of the particular packet filters corresponding to our inventive traffic filters 250. Alternatively, the filter router 230 may comprise two commercial off-the-shelf systems, including a separate high-end router and a separate firewall. Here, our inventive traffic filters 250 are embedded within the firewall component.

The filter router, as described above, is accessible by the analysis engine 232 for pre-provisioning and automated configuration. Through pre-provisioning, the analysis engine, at some predetermined time, provisions the traffic filters 250 at each of the ingress ports of the IP-in-IP tunnels 238, 240, 242, 244, and 246. Additionally, the analysis engine may also update the traffic filters 250 as needed. Through the automated configuration, the analysis engine configures the filter routers to advertise new routing information during a DDoS attack. The pre-provisioning and automated configuration communications between the filter router and analysis engine are preferably through secure communications, such as an IPSec tunnel.

The filter router maintains with each border and edge router 220, 222, 224, 226, and 228 within the ISP network 202 a pre-provisioned IP-in-IP tunnel 238, 240, 242, 244, and 246. Alternatively, if multiple filter routers are installed in the ISP network, each filter router may be assigned to only a subset of the border and edge routers in which case IP-in-IP tunnels are only maintained between a filter router and its assigned border/edge routers. Through each IP-in-IP tunnel, the filter router 230 maintains an eBGP session with its corresponding border/edge routers. In addition, the border and edge routers use the IP-in-IP tunnels to redirect DDoS and non-DDoS traffic to the filter router during a DDoS attack. As such, the IP-in-IP tunnels maintain logical adjacency between the filter router and the border and edge routers, thereby allowing the filter router and the border and edge routers to be physically separated within the ISP network 202. Note that the IP-in-IP tunnels are provisioned during network configuration, in advance of the filter router/analysis engine being notified of a possible DDoS attack.

In accordance with our invention, when a sensor, such as sensor 234 associated with customer network 204, detects a DDoS attack and notifies the analysis engine 232 of this event, the analysis engine configures the filter router 230 to advertise new routing information. The filter router advertises this new routing information using the eBGP session it maintains with each border and edge router. The new routing information advertised by the filter router instructs the border and edge routers that all DDoS and non-DDoS traffic destined for the customer network 204, for example, should now be routed to the filter router 230 via the IP-in-IP tunnels.

Once the border and edge routers are reconfigured as just described, the filter router 230 begins receiving both DDoS and non-DDoS traffic on the ingress ports of the IP-in-IP tunnels 238, 240, 244, and 246. At the ingress port of the filter router of each IP-in-IP tunnel 238, 240, 244, and 246 is the set of predefined/pre-provisioned traffic filters 250. The redirected traffic from the border/edge routers is automatically passed through these filters during the DDoS attack in order to remove the malicious traffic. The traffic filters in turn pass the non-DDoS traffic, which the filter router then routes back onto the ISP network 202 for routing towards edge router 226 and customer network 204. Note that the filter router does not use IP-in-IP tunnel 242 (assuming customer network 204 is under attack) to route the non-DDoS traffic to the customer network 204.

Regarding the predefined/pre-provisioned traffic filters 250, there are several types in accordance with our invention. A first set of traffic filters 250 are signature-based filters that remove traffic that matches the signatures of known DDoS attack mechanisms, such as Stacheldraht and TFN2K. A second set of traffic filters 250 remove packets that have field values beyond those defined as being valid by various protocol standards. Finally, in accordance with our invention, a third set of traffic filters 250 are “ingress border router filters”. Specifically, we have discovered that traffic arriving from particular IP address blocks, which are not allocated to the ISP network 202 (or ISP customer networks 204/206) but are destined to specific IP addresses within the ISP network, can be mapped to particular peer autonomous systems 208, 210, and 212 adjacent to the ISP network 202. In other words, given traffic from any IP address block originating from addresses external to the ISP network 202, it is possible to pre-determine from which peer autonomous system 210, 212, or 208 (i.e., through which border router 220, 222, or 224) that traffic will enter the ISP network 202. Note that the external traffic associated with an IP address block may originate from the pre-determined peer autonomous system or simply use that system to enter the ISP network. This discovery is useful for further removing DDoS attack traffic because attackers often use IP spoofing to hide the source clients and agents of the attack. In other words, during a DDoS attack, malicious traffic entering the ISP network 202 from an adjacent peer autonomous system 210, 212, or 208/border router 220, 222, or 224 will often have a source IP address that does not match the typical traffic that enters the ISP network from that adjacent peer autonomous system/border router. Hence, knowing the IP address blocks that typically pass through each border router and are destined for the ISP network 202, we pre-provision a set of “ingress border router filters” at the filter router 230. A given “ingress border router filter” on the ingress port of an IP-in-IP tunnel from a given border router removes traffic that does not have a source IP address that would typically enter the ISP network through that border router. Note that in accordance with our invention, other types of traffic filters 250 beyond those described above can also be provisioned at the filter router 230.

Turning to the border and edge routers 220, 222, 224, 226, and 228, these are commercial off-the-shelf products. Other than requiring the pre-provisioning of the IP-in-IP tunnels, these systems operate as normal and do not require access by the analysis engine 232 in order to mitigate a DDoS attack.

Our inventive combination of the border/edge routers, IP-in-IP tunnels, analysis engine, and filter router/traffic filters has several advantages. First, if multiple filter routers are used, no synchronization/coordination is needed between the filter routers or between the border routers. As such, as more customer networks are added to ISP network 202 and/or more peer networks are interconnected to the ISP network, our inventive system easily scales by adding additional filter routers and border/edge routers. Second, because the DDoS and non-DDoS traffic destined for a customer network under attack is rerouted to the filter router using the IP-in-IP tunnels, the routers comprising the core of the ISP network 202 do not need to be reconfigured in order to mitigate the attack. As such, traffic directed at customer networks not under attacked is not affected. Along this same point, our inventive system does not require accessing in-service network routers, including the core network routers and more importantly the border and edge routers, in order to mitigate the attack. The border and edge routers are reconfigured using the existing capabilities/protocols (i.e., eBGP) of the ISP network. Third, because the high-end filter router removes the malicious traffic, the malicious traffic never taxes the more limited resources of the edge routers 226/228, access links 216/217, and access routers 214/215. Hence, the non-DDoS traffic experiences minimal delay once an attack is mitigated.

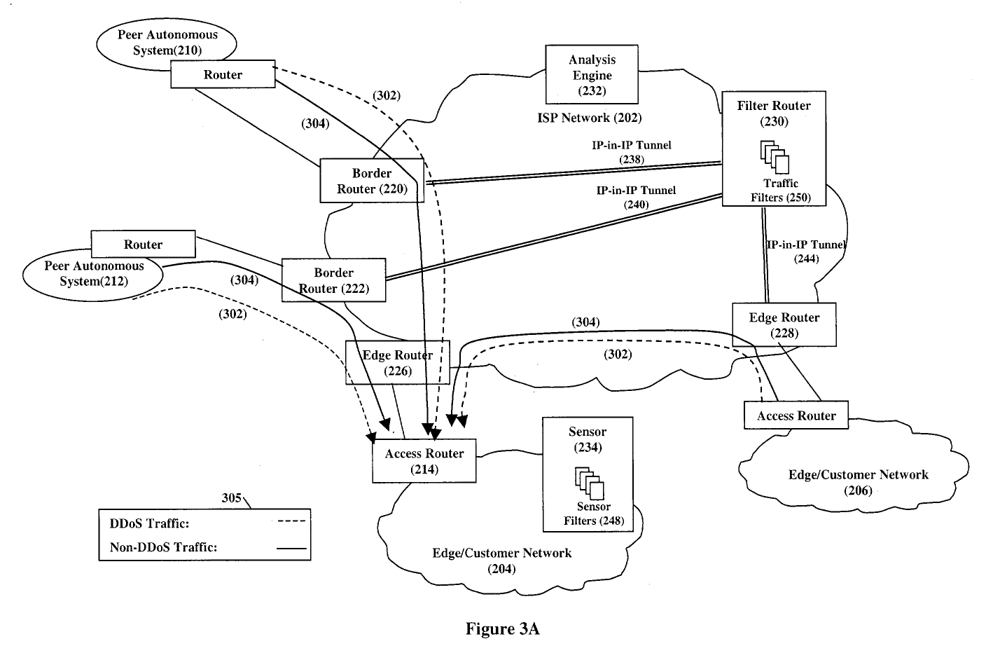

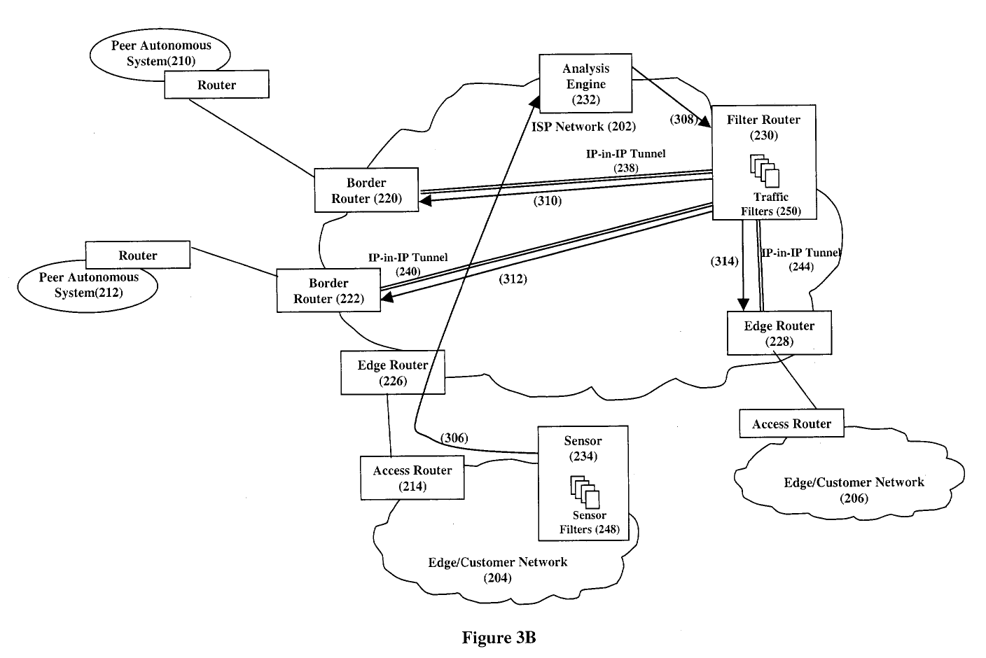

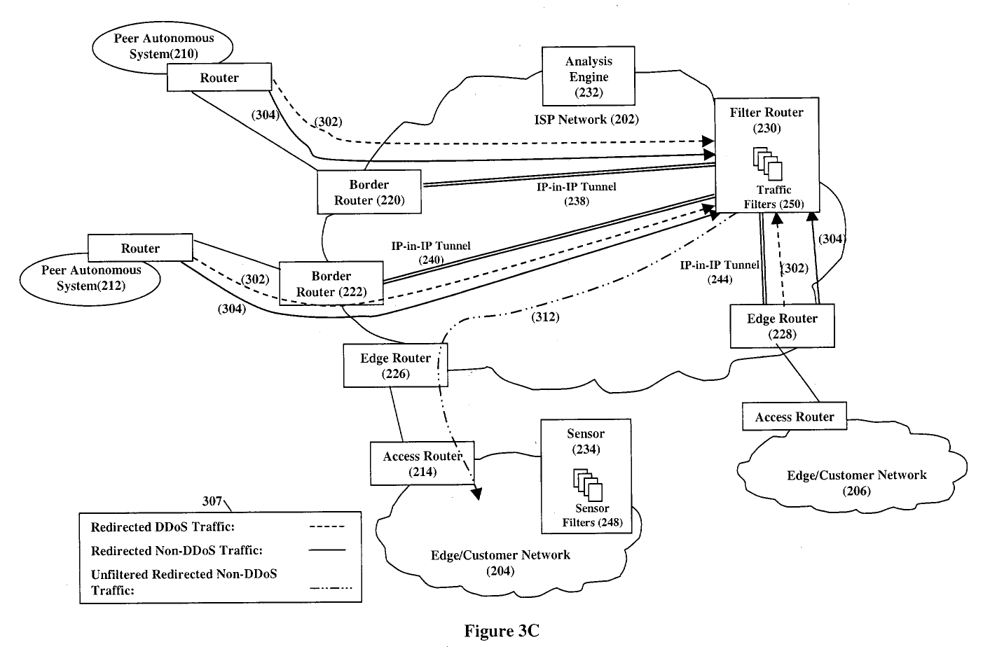

FIGS. 3A-3C are a simplified network illustrating the operation of our inventive DDoS detection and mitigation system. In FIG. 3A, customer network 204 is receiving malicious DDoS traffic 302 and desired non-DDoS traffic 304 (element 305 providing a key for the DDoS and non-DDoS traffic) from peer autonomous systems 210 and 212 and customer network 206. As shown by FIG. 3B, the sensor filters 248 of sensor 234 detect the DDoS attack and the sensor issues an attack notification 306 to the analysis engine 232. The analysis engine in turn configures the filter router 230, as shown by arrow 308, to advertise new routing information to the border and edge routers 220, 222, and 228, which advertising of new routing information is shown by arrows 310, 312, and 314. The filter router advertises the new routing information through the eBGP sessions it maintains with the border and edge routers over the IP-in-IP tunnels 238, 240, and 244. As shown by FIG. 3C, in response to the new routing information, the border and edge routers redirect the DDoS traffic 302 and non-DDoS traffic 304 (element 307 providing a key for the redirected DDoS and non-DDoS traffic) intended for the customer network 204 to the filter router 230 over the IP-in-IP tunnels 238, 240, and 244. Through the traffic filters 250, the filter router removes the DDoS traffic from incoming traffic received over the IP-in-IP tunnels and passes the non-DDoS traffic back onto the ISP network 202 towards the customer network, as shown by arrow 312.

The above-described embodiments of our invention are intended to be illustrative only. Numerous other embodiments may be devised by those skilled in the art without departing from the spirit and scope of our invention.

### ACRONYMS

DoS: Denial of Service

DDoS: Distributed Denial of Service

DSL: digital Subscriber Line

eBGP: External Border Gateway Protocol

ICMP: Internet Control Message Protocol

IDMEF: Intrusion Detection Message Exchange Format

IP: Internet Protocol

IPSec: IP Security

ISDN: Integrated Services Digital Network

ISP: Internet Service Provider

SOHO: Small Office/Home Office

TCP: Transmission Control Protocol

UDP: User Datagram Protocol

XML: Extensible Markup Language

We claim:

1. A system for mitigating service attacks against an edge network that is connected to an Internet service provider (ISP) network, wherein the ISP network comprises a plurality of border routers and a filter router, said system comprising:
an analysis engine in the ISP network, which analysis engine is notified when a service attack against the edge network is detected, and
a plurality of traffic filters provisioned on the filter router,
wherein the analysis engine, upon being notified of a service attack, configures the filter router to advertise new routing information to one or more of the border routers, the advertised new routing information instructing the border routers to redirect service attack and non-service attack traffic intended for the edge network to the filter router, and wherein the traffic filters remove the redirected service attack traffic from the ISP network and allow the redirected non-service attack traffic to proceed.

2. The system of claim 1 further comprising a plurality of sensor filters, which filters have access to traffic entering the edge network and analyze the accessed traffic to detect the service attacks against the edge network.

3. The system of claim 2 wherein the service attacks include denial of service and distributed denial of service attacks (collectively DDoS) and wherein the sensor and traffic filters comprise DDoS signature-based filters that perform signature-based detection and removal, respectively, of DDoS flood traffic.

4. The system of claim 3 wherein the sensor filters further comprise DDoS signature-based filters that perform signature-based detection of DDoS control traffic to determine whether the edge network is originating a DDoS attack.

5. The system of claim 2 wherein the sensor and traffic filters comprise packet header-based filters that perform detection and removal, respectively, of service attack traffic based on whether headers of packets comprising the traffic have field values beyond defined ranges.

6. The system of claim 2 wherein the sensor filters comprise volume-based filters that perform volume-based detection of service attack flood traffic.

7. The system of claim 1 wherein the traffic filters comprise filters that remove a given packet if the packet enters the ISP network through a given border router and has an originating IP address that does not match a block of IP addresses that are expected to enter the network through the given border router.

8. The system of claim 2 wherein the analysis engine prior to a service attack is capable of pre-provisioning the sensor filters and the traffic filters.

9. The system of claim 8 wherein the analysis engine is capable of disabling one or more provisioned traffic filters and sensor filters in order to modulate the detection severity of the system.

10. The system of claim 1 further comprising packet-drop-counters at the filter router that count packets removed from the redirected service attack and non-service attack traffic, wherein the analysis engine is capable of polling the packet-drop-counters and using the counts to determine through which border router or border routers the attack is originating.

11. The system of claim 1 further comprising a plurality of IP-in-IP tunnels, wherein each tunnel is provisioned between the filter router and a border router and wherein the redirected service attack and non-service attack traffic is routed from the border routers to the filter router through the IP-in-IP tunnels.

12. The system of claim 11 wherein the plurality of traffic filters are provisioned at an ingress point of each IP-in-IP tunnel at the filter router.

13. The system of claim 1 wherein the ISP network further comprises a plurality of edge routers, wherein the analysis engine, upon being notified of the service attack, configures the filter router to advertise the new routing information to one or more of the edge routers to redirect to the filter router service attack and non-service attack traffic intended for the edge network.

14. A system for mitigating denial of service attacks and distributed denial of service attacks (collectively DDoS) against an edge network connected to an Internet service provider (ISP) network, said system comprising:
an analysis engine within the ISP network,
a plurality of border routers within the ISP network, and
a filter router within the ISP network,
wherein the analysis engine is notified when a DDoS attack is detected in the edge network and configures the filter router in response to the attack notification to advertise new routing information to one or more of the border routers instructing the border routers to redirect DDoS and non-DDoS traffic intended for the edge network to the filter router, and wherein the filter router removes the DDoS traffic and routes the non-DDoS traffic back onto the ISP network for routing to the edge network.

15. The system of claim 14 further comprising a plurality of sensor filters for determining whether network traffic entering the edge network includes a DDoS attack.

16. The system of claim 14 further comprising a plurality of traffic filters within the filter router wherein the redirected DDoS and non-DDoS traffic is automatically passed through the traffic filters for removing the DDoS traffic and wherein the traffic filters comprise filters that remove a given packet if the packet enters the ISP network through a given border router and has an originating IP address that does not match a block of IP addresses that are expected to enter the ISP network through the given border router.

17. The system of claim 15 wherein the sensor filters can be automatically updated in order to detect and mitigate new types of DDoS attacks.

18. The system of 16 wherein one or more of the traffic filters can be disabled in order to modulate the detection severity of the system.

19. The system of claim 14 further comprising a plurality of IP-in-IP tunnels, wherein each tunnel is between the filter router and a border router and wherein the redirected DDoS and non-DDoS traffic is routed from the border routers to the filter router through the IP-in-IP tunnels.

20. The system of claim 14 further comprising a plurality of packet-drop-counters incremented by the filter router as DDoS packets are dropped, wherein the packet-drop-counters are used to indicate through which border router or border routers the attack is originating.

21. A method for mitigating service attacks against an edge network connected to an Internet service provider (ISP) network, wherein the ISP network comprises a plurality of border routers and a filter router, said method comprising the steps of:
detecting a service attack directed at the edge network,
sending an attack notification to the ISP network,
in response to the attack notification, advertising new routing information to the border routers wherein the routing information is to redirect service attack and non-service attack traffic destined for the edge network to the filter router,
filtering by the filter router the redirected service attack and non-service attack traffic to remove the service attack traffic, and
forwarding the non-service attack traffic to the edge network.

22. The method of claim 21 wherein the service attack and non-service attack traffic is redirected from the border routers to the filter router through IP-in-IP tunnels.

23. The method of claim 21 wherein the filtering step is performed by a plurality of traffic filters.

24. The method of claim 23 wherein the traffic filters comprise filters that remove a given packet if the packet enters the ISP network through a given border router and has an originating IP address that does not match a block of IP addresses that are expected to enter the network through the given border router.

25. The method of claim 23 further comprising the step of disabling one or more of the traffic filters in order to modulate the detection severity.

26. The method of claim 21 further comprising the steps of:
detecting service attack control traffic directed at the edge network, and
sending a service attack control traffic notification to the ISP network.

27. The method of claim 21 further comprising the steps of:
periodically polling a plurality of packet-drop-counters incremented by the filter router as service attack traffic is removed, and
using the packet-drop-counters to determine through which border router or border routers the attack is originating.

28. The method of claim 21 wherein the service attacks comprise denial of service and distributed denial of service attacks.
